(19) United States
(12) Patent Application Publication
(10) Pub. No.: US 2007/0212019 A1
(43) Pub. Date: Sep. 13, 2007

(54) Broadcast recording apparatus and brodcast recording method

(76) Inventors: Takahiro Kimura, Fukaya-shi (JP); Akira Miyazawa, Saitama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/707,009

(22) Filed: Feb. 16, 2007

(30) Foreign Application Priority Data
Feb. 20, 2006 (JP) 2006-043208

(51) Int. Cl. H04N 5/91

(52) U.S. Cl. 386/83

(57) ABSTRACT

According to one embodiment, a broadcast recording apparatus includes a tuner unit which receives a broadcast signal, demodulates the received signal, and then, outputs a signal of a program, a recording unit which records the program signal outputted by the tuner unit in a recording medium together with management information of the program, a reproducing unit which reproduces the program signal recorded in the recording medium, a reservation setting unit which, upon receiving an instruction signal while the reproducing unit reproduces the program signal, sets reservation information on a program of a next time in accordance with the management information, and a reserved image recording unit which, when a time indicated by the reservation information has come, controls the recording unit to record the program signal in the recording medium.

### CROSS-REFERENCE TO RELATED APPLICATIONS

This application is based upon and claims the benefit of priority from Japanese Patent Application No. 2006-043208, filed Feb. 20, 2006, the entire contents of which are incorporated herein by reference.

### BACKGROUND

1. Field

The present invention relates to a broadcast recording apparatus for recording a program signal, and particularly to a broadcast recording apparatus and a broadcast recording method capable of easily carrying out reserved image recording of a next program with respect to a program in reproduction.

2. Description of the Related Art

Recently, with prevalence of a digital device, a broadcast receiving apparatus such as a hard disk recorder has been generally used. It is now possible to easily record/reproduce more video image information than a case of a recording/reproducing process using a conventional video tape recorder (VTR). In such a broadcast receiving apparatus, it is now possible to further easily carry out an unattended image recording process utilizing electronic program guide supplied from a broadcast station or a server. Thus, reserved image recording is facilitated, and many contrivances for image recording reservation have been made.

That is, in patent document 1 (Japanese Patent Application No. 2000-23074), there is disclosed a technique of handling an actually viewed television program as an image recording candidate, and then, image-recording the contents of the broadcast at a time interval of the next date or next week in accordance with the candidate.

In addition, in patent document 2 (Japanese Patent Application No. 2004-266658), there is disclosed a technique capable of automatically making a search for a program to be recorded specified by a user and its associated program.

In addition, in patent document 3 (Japanese Patent Application No. 2002-199294), there is disclosed a broadcast program recording apparatus capable of automatically image-recording a broadcast program that a user periodically views.

However, in conventional techniques of the patent documents 1 to 3 described above, there is a problem that it is difficult to make an operation for image recording reservation of a next program or image recording reservation of a program of a next week while reproducing a video image file that has already been image-recorded.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram depicting an example of a configuration of a broadcast recording apparatus according to an embodiment of the present invention;

FIG. 2 is a flow chart showing an example of a drama series reservation process while the broadcast recording apparatus carries out broadcast receiving;

FIG. 3 is a flow chart showing another example of a drama series reservation process while the broadcast recording apparatus carries out broadcast receiving;

FIG. 4 is a flow chart showing an example of a broadcast cycle judgment process that the broadcast recording apparatus carries out;

FIG. 5 is a flow chart showing an example of a drama series reservation process while the broadcast recording apparatus carries out video image file reproduction;

FIG. 6 is a flow chart showing another example of a drama series reservation process while the broadcast recording apparatus carries out video image file reproduction;

FIG. 7 is an illustrative view showing an example of a remote controller for use in the broadcast recording apparatus;

FIG. 8 is a view showing an example of a drama series reservation screen on a broadcast screen that the broadcast recording apparatus displays;

FIG. 9 is a view showing an example of an image recording setting screen that the broadcast recording apparatus displays;

FIG. 10 is a view showing an example of a reservation list that the broadcast recording apparatus displays;

FIG. 11 is a view showing an example of a drama series reservation screen on a program table screen that the broadcast recording apparatus displays; and

FIG. 12 is a view showing an example of a screen for displaying an overlap on another reservation that the broadcast recording apparatus displays.

### DETAILED DESCRIPTION

Various embodiments according to the invention will be described hereinafter with reference to the accompanying drawings. In general, according to one embodiment of the invention, a broadcast recording apparatus comprising: a tuner unit which receives a broadcast signal, demodulates the received signal, and then, outputs a signal of a program; a recording unit which records the program signal outputted by the tuner unit in a recording medium together with management information of the program; a reproducing unit which reproduces the program signal recorded in the recording medium; a reservation setting unit which, upon receiving an instruction signal while the reproducing unit reproduces the program signal, sets reservation information on a program of a next time in accordance with the management information; and a reserved image recording unit which, when a time indicated by the reservation information has come, controls the recording unit to record the program signal in the recording medium.

Now, embodiments of the present invention will be described in detail with reference to the accompanying drawings.

A term “drama series reservation” repeatedly appearing in the specification designates reservation of a series-related program in a broad sense without being limited to a drama series, and merely symbolically suggests a drama series. Therefore, this term indicates a case of reserving plenty of series-related programs with one item of reservation information.

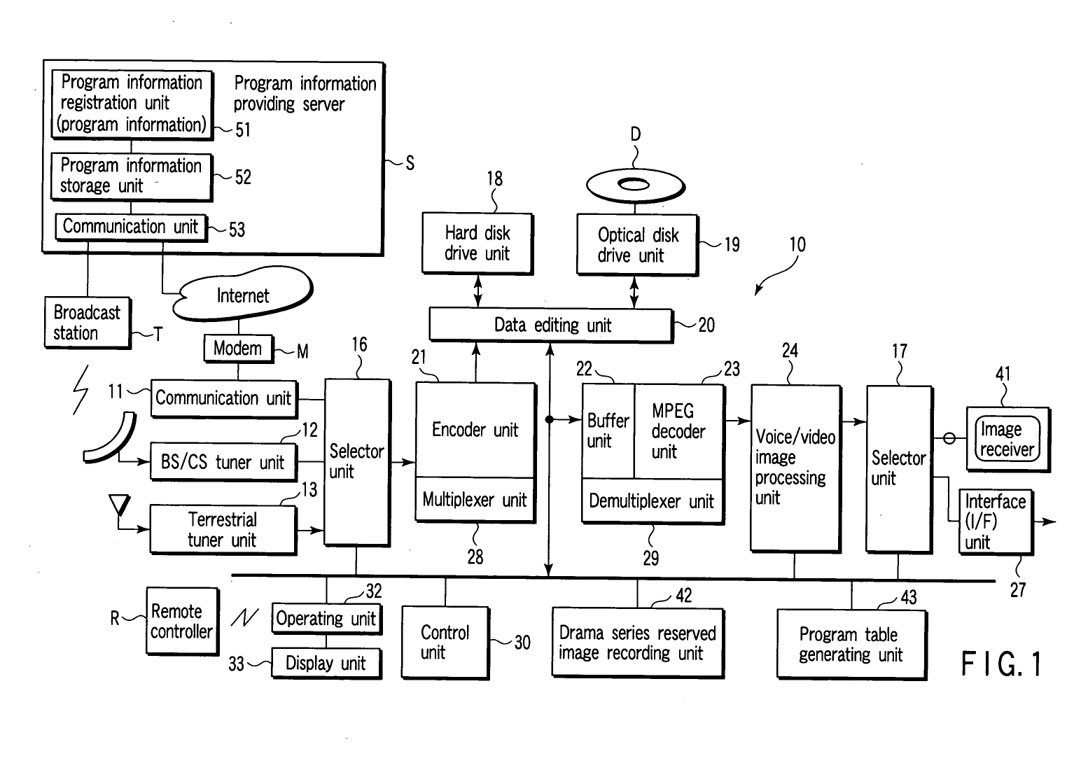

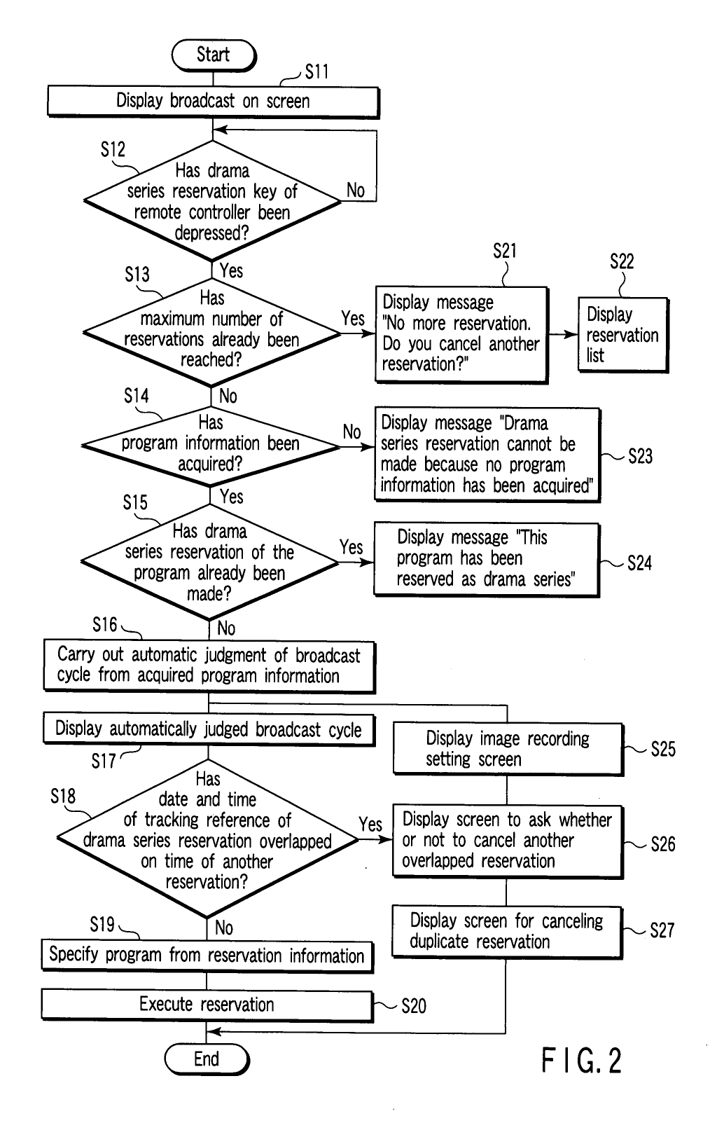

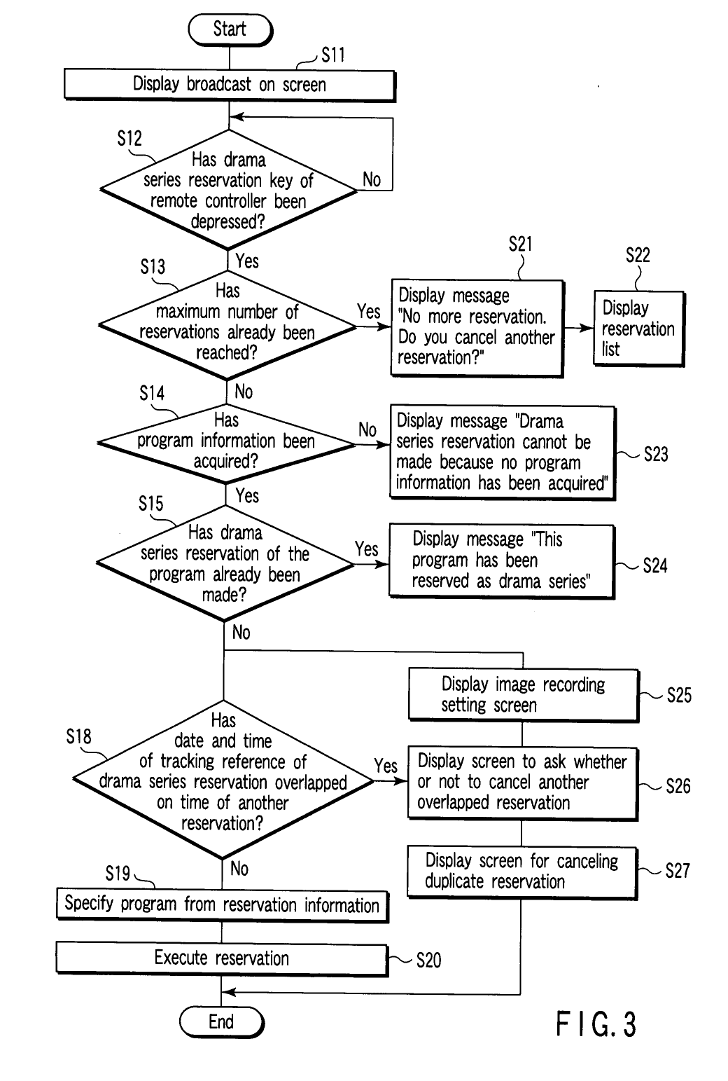

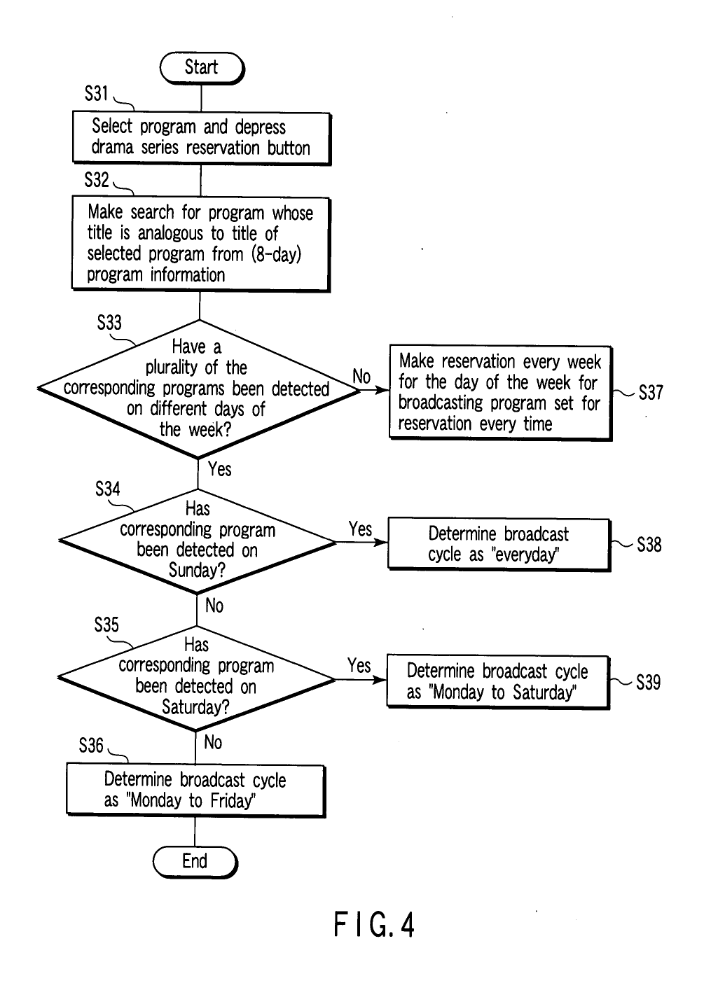

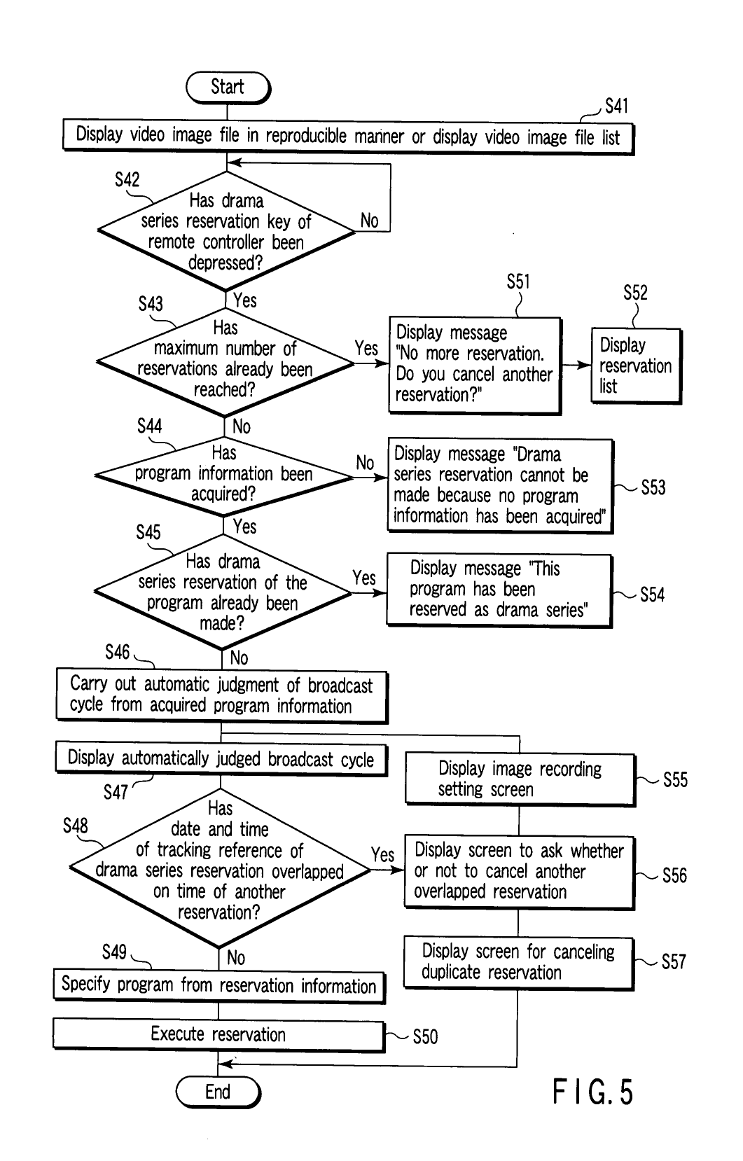

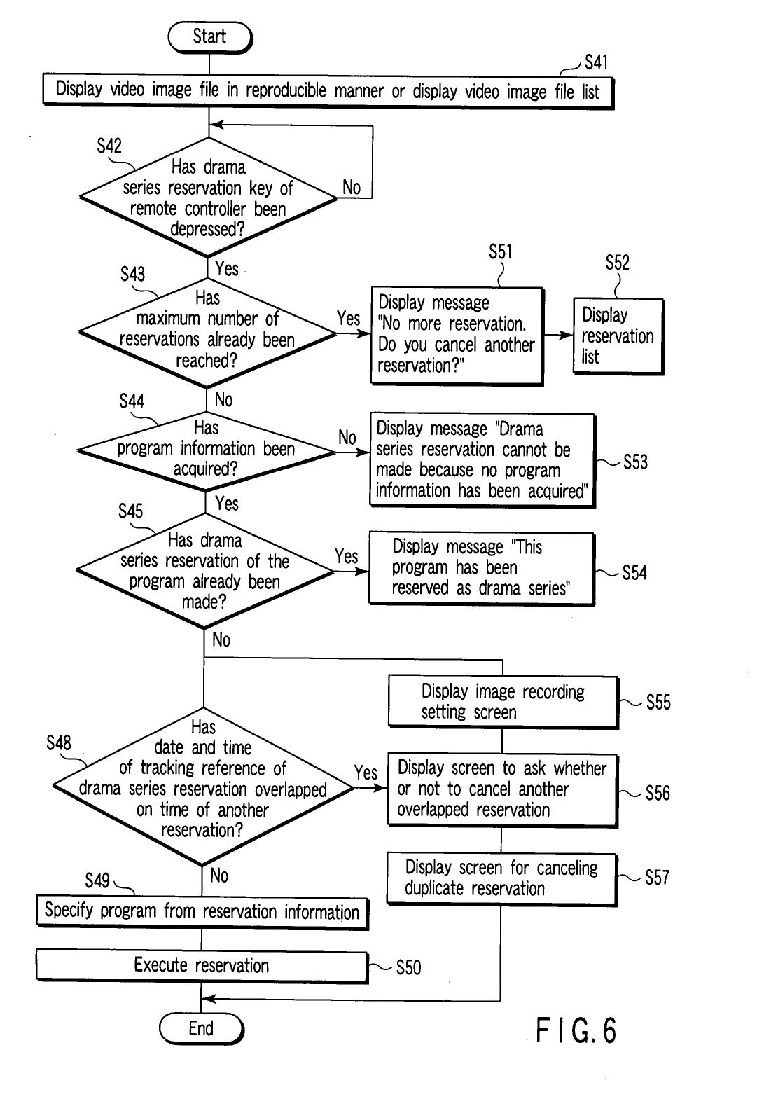

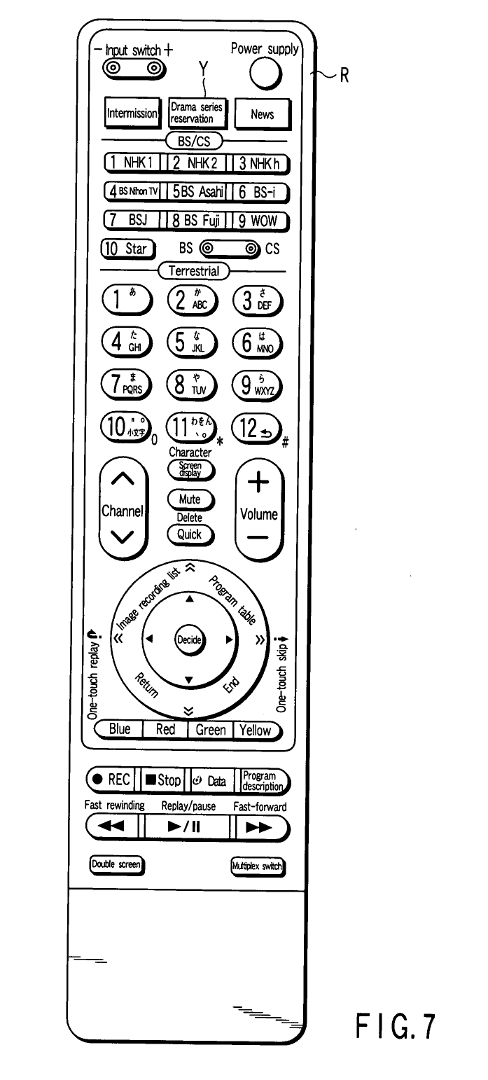

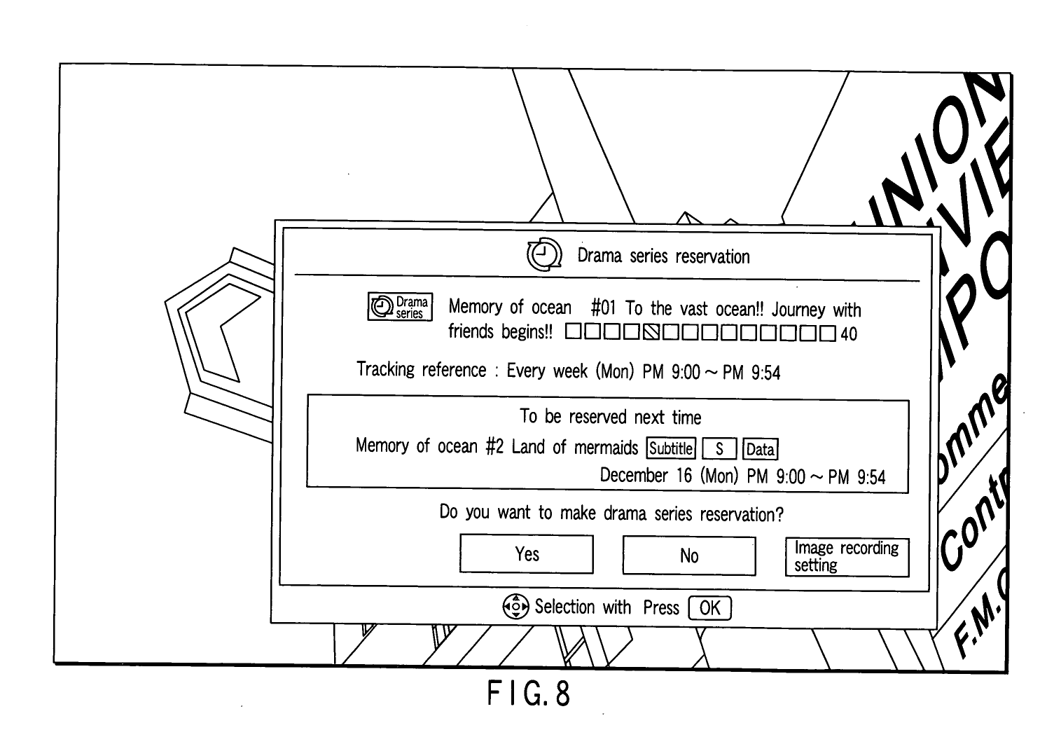

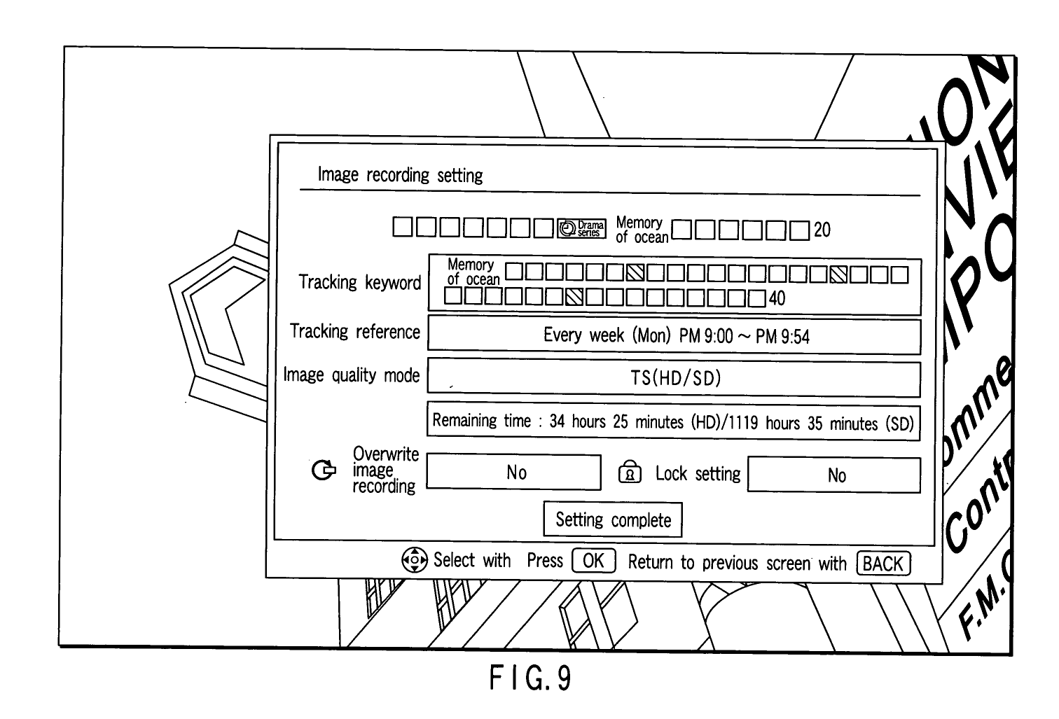

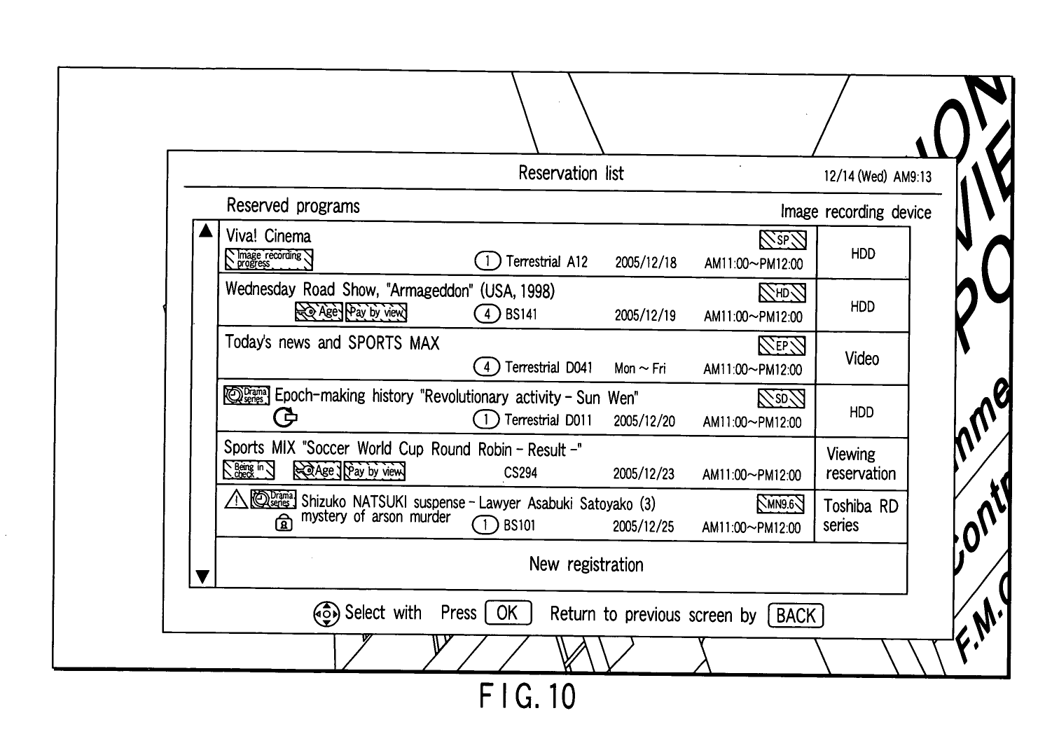

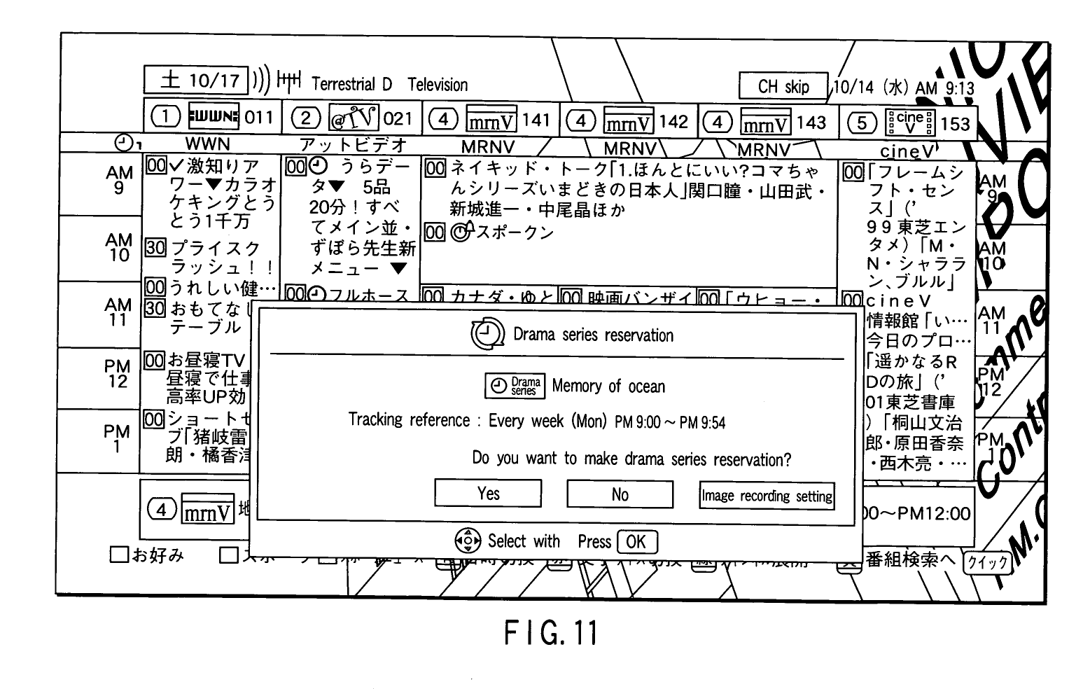

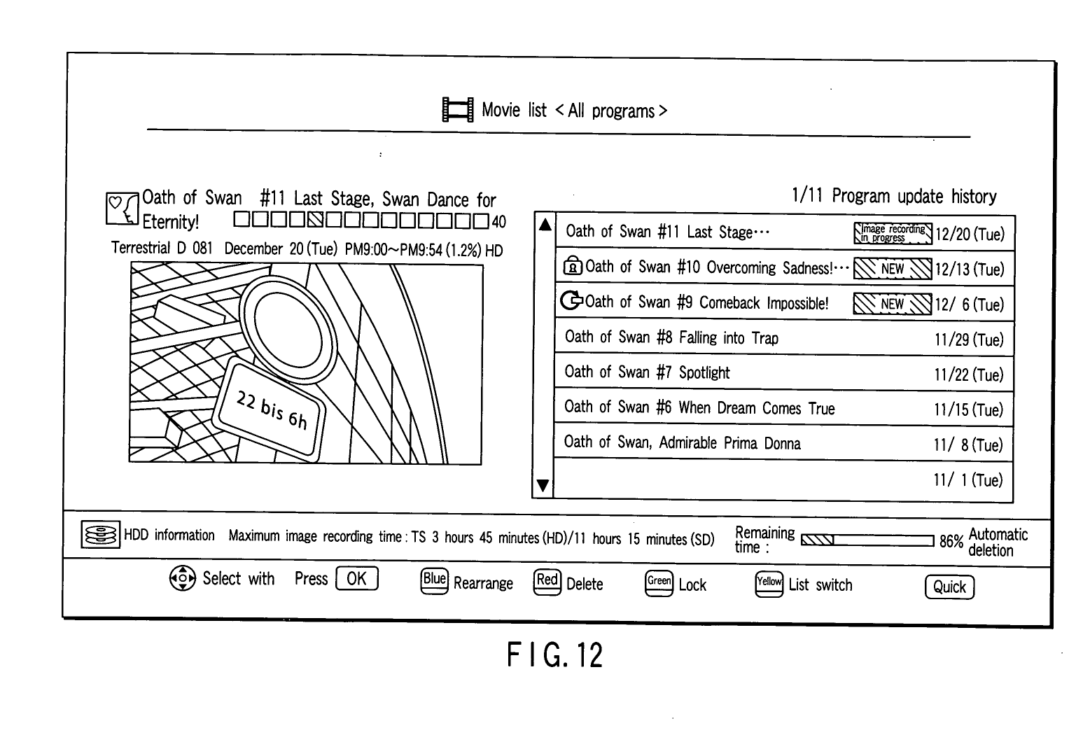

FIG. 1 is a block diagram depicting an example of a configuration of a broadcast recording apparatus according to an embodiment of the present invention; FIG. 2 is a flow chart showing an example of a drama series reservation process while the broadcast recording apparatus carries out broadcast receiving; FIG. 3 is a flow chart showing another example of a drama series reservation process while the broadcast recording apparatus carries out broadcast receiving; FIG. 4 is a flow chart showing an example of a broadcast cycle judgment process that the broadcast recording apparatus carries out; FIG. 5 is a flow chart showing an example of a drama series reservation process while the broadcast recording apparatus carries out video image file reproduction; FIG. 6 is a flow chart showing another example of a drama series reservation process while the broadcast recording apparatus carries out video image file reproduction; FIG. 7 is an illustrative view showing an example of a remote controller for use in the broadcast recording apparatus; FIG. 8 is a view showing an example of a drama series reservation screen on a broadcast screen that the broadcast recording apparatus displays; FIG. 9 is a view showing an example of a image recording setting screen that the broadcast recording apparatus displays; FIG. 10 is a view showing an example of a reservation list that the broadcast recording apparatus displays; FIG. 11 is a view showing an example of a drama series reservation screen on a program table screen that the broadcast recording apparatus displays; and FIG. 12 is a view showing an example of a screen for displaying an overlap on another reservation that the broadcast recording apparatus displays.

<Broadcast Recording Apparatus According to an Embodiment of the Present Invention>

(Configuration)

First, in a broadcast receiving apparatus 10 of FIG. 1, as an example, there is shown a digital television having a recording function while a tuner or the like is used as a source. In addition, it is preferable that the broadcast receiving apparatus 10 should be a hard disk recorder having a tuner or the like and a recording function.

Therefore, in the following description of the embodiments section with reference to FIG. 1, while a description will be given in detail with respect to a digital television having a recording function, this detailed description can be construed as a description of a hard disk recorder having exactly the same function by separating an image receiver 41 from the configuration shown in FIG. 1.

In FIG. 1, the broadcast receiving apparatus 10 that is a digital television has two types of disk drives. In other words, this apparatus has a hard disk drive unit 18 that drives a hard disk H as a first medium and an optical disk drive unit 19 that rotationally drives an optical disk D serving as an information recording medium capable of constructing a video file as a second medium and that executes information reading and writing. In addition, a control unit 30 is connected to each unit via a data bus B in order to control a whole operation. However, in the case of carrying out the present invention, the optical disk drive unit 19 is not always a necessary constituent element.

In addition, the broadcast receiving apparatus 10 of FIG. 1 primarily comprises: an encoder unit 21 that configures an image recording side; an MPEG decoder unit 23 that configures a reproducing side; and a control unit 30 that controls an operation of a main body of the apparatus. The broadcast receiving apparatus 10 has an input side selector 16 and an output side selector 17. A communication unit 11 such as LAN, a so-called satellite broadcast (BS/CS) digital tuner unit 12, and a so-called terrestrial digital/analog tuner unit 13 are connected to the input side selector 16, and a signal is outputted to the encoder unit 21. In addition, a satellite antenna is connected to the BS/CS digital tuner unit 12, and a terrestrial antenna is connected to the terrestrial digital/analog tuner unit 13. In addition, the broadcast receiving apparatus 10 has: an encoder unit 21; a signal editing unit 20 that receives an output from the encoder unit 21 and carries out desired data processing such as data editing; a hard disk drive unit 18 connected to the signal editing unit 20; and an optical disk drive unit 19. Further, the broadcast receiving apparatus 10 has: an MPEG decoder unit 23 that receives and decodes signals from the hard disk drive unit 18 and the optical disk drive unit 19; an encoder unit 21; a buffer unit 22; an MPEG decoder unit 23; a multiplexer unit 28; a demultiplexer unit 29; a control unit 30; a drama series reserved image recording unit 42; and a program table generating unit 43. These units each are connected to the control unit 30 via the data bus B. Further, an output of the selector unit 17 is supplied to the image receiver 41 or is supplied to an external device via an interface unit 27 that makes communication with the external device.

Further, the broadcast receiving apparatus 10 has an operating unit 32 connected to the control unit 30 via the data bus B, the operating unit receiving an operation of a user or an operation of a remote controller R. Here, the remote controller R enables an operation that is substantially identical to that of the operating unit 32 provided at the main body of the broadcast receiving apparatus 10. This remote controller enables a variety of settings such as settings of a recording/reproducing instruction of the hard disk drive unit 18 or the optical disk drive unit 19, an edit instruction, and tuner operation and reserved image recording.

(Program Information Providing Server)

Furthermore, a description will be given with respect to a program information providing server S for providing program information to the broadcast receiving apparatus 10 via the communication unit 11 or the like. The program information providing server S has: a program information registration unit 51 for inputting program information including program identification information for identifying a broadcast program name and broadcast time information on a program that corresponds to this program identification information (including a broadcast start time and a broadcast time or free program information and the like, for example); a program information storage unit 52 for storing the program information inputted by the program information registration unit 51; and a communication unit 53 for transmitting the information stored in the program information storage unit 52 to a desired terminal via a network or the like.

The program information providing server S having such constituent elements is provided as a facility of an organization that provides service, and program information including broadcast programs, program identification information on the broadcast programs, and broadcast time information is uploaded in the server. Then, if a change occurs in this program information, the program information registration unit 51 immediately inputs changed information and carries out an updating process of the program information storage unit 52. At this time, in the case where program information having the same program identification information as the program information already held in the program information providing server S has been inputted, the program information providing server S replaces the program information held in the program information storage unit 52 with the latest information.

The program information providing server S relays the Internet, for example, via the communication unit 53; provides program information to a broadcast station T via a modem M or as shown in FIG. 1; superimposes the provided program information on a broadcast signal (such as a terrestrial digital signal, a terrestrial analog signal, a satellite broadcast digital signal, or a satellite broadcast analog signal) of the broadcast station T; and provides the program information or the like to the broadcast receiving apparatus 10.

(Basic Operation)

Reproducing Broadcast Contents

In the thus configured broadcast receiving apparatus 10 that is a digital television, a broadcast signal is received under the control of the control unit 30 or the like and broadcast contents from the BS/CS tuner 12 or the terrestrial digital/analog tuner unit 13 are displayed on the image receiver 41 in accordance with an operating signal responsive to an operation of the user's remote controller R or the operating unit 32.

Recording Process

Now, an operation at the time of recording will be described in detail including those of other embodiments. As an input side of the broadcast receiving apparatus 10, the communication unit 11 such as LAN is connected to an external device to make communication with a program information providing server or the like through a communication channel such as the Internet via a modem or the like, for example, or to download broadcast contents or the like. In addition, the BS/CS digital tuner unit 12 and the terrestrial digital/analog tuner unit 13 each channel-select and demodulate a broadcast signal via an antenna, input a video image signal and a voice signal, and are compatible with a variety of broadcast signals. Examples of such broadcast signals include: a terrestrial analog broadcast signal; a terrestrial digital broadcast signal; a BS analog broadcast signal; a BS digital broadcast signal; a CS digital broadcast signal or the like without being limited thereto. In addition, the number of the tuner units provided is not necessarily one, and there is included a case of providing two or three and more terrestrial tuner units or BS/CS tuner units so as to function in parallel in response to a reserved image recording request.

In addition, the communication unit 11 described previously may be an IEEE1394 interface and can receive digital contents from an external device over a network. In addition, this communication unit can receive a luminance signal or a color difference signal, a video image signal such as a composite signal, or a voice signal from an input terminal (not shown). These signals are selectively supplied to the encoder unit 21 while inputs thereof are controlled by the selector 16 controlled under the control unit 30 or the like.

The encoder unit 21 has video and audio analog/digital converters that digitize an analog video signal or an analog audio signal inputted by the selector 16; a video encoder; and an audio encoder. Further, this encoder unit includes a subsidiary video image encoder. An output of the encoder unit 21 is converted into a compression format such as a predetermined MPEG, and then, is supplied to the control unit 30 described previously.

In addition, the BS/CS digital tuner 12 or the like is not always incorporated. It is preferable that this digital tuner should be externally provided via a data input terminal and supply a received digital signal to the encoder unit 21 or the control unit 30 via the selector unit 16.

Here, the apparatus of FIG. 1 can supply information (pack such as video, audio, and subsidiary video image data) encoded by the encoder unit 21 and management information produced thereby to the hard disk drive unit 18 or the optical disk drive unit 19 via the control unit 30 and record the thus supplied items of information in the hard disk drive unit 18 or an optical disk D. In addition, this apparatus can record the information recorded in the hard disk drive unit 18 or the optical disk D in the optical disk D or the hard disk drive 18, respectively, via the control unit 30 or the optical disk drive unit 19 in an exchangeable manner.

The signal editing unit 20 can carry out an editing process such as partially deleting video objects of a plurality of programs recorded in the hard disk drive unit 18 or the optical disk D or connecting objects of different programs to each other.

Reproducing Process or the Like

Now, a process for reproducing recorded information will mainly be described in detail including those according to other embodiments.

The MPEG decoder unit 23 comprises a video processor that properly combines a decoded subsidiary video image with a decoded main video image and that superimposes and outputs a menu, a highlight button, subtitles or any other subsidiary video image on the main video image.

An output audio signal of the MPEG decoder unit 23 is supplied to a speaker after being analog-converted by a digital/analog converter (not shown), via the selector unit 17 or is supplied to an external device via an interface (I/F) unit 27. The selector unit 17 is controlled by means of a select signal from the control unit 30. In this manner, the selector unit 17 can directly select a signal having passed through the encoder unit 21 when a digital signal from each of the tuner units 12 and 13 is directly monitored.

Reserved Image Recording Process

Based on electronic program information acquired from the communication unit 11 or the tuners 12 and 13, an image recording reservation process can be carried out in accordance with a program specified by a user's operation of a remote controller R or the like using a reserved image recording unit (program table generating unit) 43. In addition, a program table based on the acquired electronic program information can be displayed on a screen. In addition, based on reserved image recording information and by working of the control unit 30 and the program table generating unit 43, when a reservation time has come, a video image/voice signal obtained by demodulating the program information received by the BS/CS digital tuner unit 12 or the terrestrial digital/analog tuner unit 13 is recorded (reserved image-recorded) in the hard disk drive unit 18 through an encoding process of the encoder 21 or the like.

The broadcast receiving apparatus 10 according to the present embodiment thus has a comprehensive function and carries out a recording/reproducing process using an optical disk D or the hard disk drive unit 18 with respect to a plurality of sources.

<Program Reservation Setting Process According to an Embodiment of the Present Invention>

Now, with reference to the flow charts of FIGS. 2 to 6, a description will be given in detail with respect to a program reservation setting process according to an embodiment of the present invention.

(Image Recording Reservation Process while Receiving Broadcast)

First, in the broadcast receiving apparatus 10 described above, a broadcast of a desired program according to a channel specified by a remote controller R or the like is tuned/demodulated by means of the tuner unit 12 or the like, and then, the resulting broadcast is displayed on a screen by means of the image receiver 41 or the like (step S11). In this state, a drama series reserved image recording unit 42 judges whether or not a drama series reservation key Y of the remote controller R has been depressed (step S12).

If a maximum number of reservations has been reached (step S13), the drama series reserved image recording unit 42 displays a message indicating “No more reservation. Do you cancel another reservation?” (step S21). Next, a reservation list shown in FIG. 10 is displayed by working of the drama series reserved image recording unit 42 (step S22).

Further, if the maximum number of reservations has not been reached in step S13, the process goes to step 14 in which it is judged whether or not program information has been acquired (step S14). If the information has not been acquired, a message indicating “drama series reservation cannot be made because no program information has been acquired.” is displayed (step S23).

This program information (program management information) is provided as program information included in a broadcast signal if a broadcast of a video image file is a terrestrial digital broadcast, a BS digital broadcast, or CS digital broadcast. In addition, if a broadcast of a video image file is a terrestrial analog signal, the above program information is provided as program information supplied from the electronic program information which has been supplied from the program information providing server S and acquired via the Internet, a modem, or the tuner unit 13.

In addition, if program information has not been acquired in step S14, it is judged whether or not a drama series reservation of this program has been made (step S15). If the drama series reservation of this program has been made, a message indicating “This program has been reserved as a drama series” is displayed (step S24).

If the drama series reservation of this program has not been made yet, automatic judgment of a broadcast cycle is made from the acquired program information. This automatic judgment process will be described in detail with reference to FIG. 4 (step S16). Program information (program management information) may be electronic program guide (EPG) or may be title information, channel information, broadcast time information, performer information and the like without being limited thereto, which are included in broadcast signals such as a terrestrial digital broadcast signal and a BS digital broadcast signal. Then, the automatically judged broadcast cycle is displayed as shown in FIG. 8 (step S17).

From the screen of FIG. 8, a user can easily set a next-round reservation or an every-week reservation with respect to a specific program of a currently viewed broadcast by pressing an icon “Yes” responsive to a message display “Do you want to make a drama series reservation?”. Further, an image recording setting screen of FIG. 9 can be invoked by operating an icon “image recording setting” of FIG. 8. Here, image recording conditions such as a tracking keyword, a tracking reference, an image quality mode, overwrite image recording, or lock setting can be set.

Then, it is judged whether or not a date and time of a tracking reference of a drama series reservation overlap on another reservation time (step S18), and a screen is displayed to ask a user whether or not to cancel another overlapped reservation (step S26). Then, a screen listing reservation information that has overlapped is displayed in order to cancel duplicate reservation by working of the drama series reserved image recording unit 42 (step S27).

On the other hand, in step S18, if the date and time of the tracking reference do not overlap on another reservation time, reservation information on a next program of the corresponding program or reservation information on the corresponding program every week is specified from the program information recorded to be associated with the already recorded video image file.

Next, a specific date and time of a program of a next time or a program of every week is specified based on channel information, time information, title information or the like included in this reservation information (step S19). Specifically, a broadcast cycle of “every week”, “every day”, “Monday to Saturday” or the like is determined by the judgment process of FIG. 4. In the range of this broadcast cycle and a plus or minus several hours from the date and time of the current broadcast, it is judged that a program of a title approximate to the current broadcast title is a next program or a program of every week. Based on the thus specified reservation information, when the date and time specified by this reservation information have come, reserved image recording is executed (step S20).

Specific Procedures for Judgment Process

Now, specific procedures for the judgment process of FIG. 4 will be described below.

First, “Yes” is selected from a drama series reservation screen as shown in FIG. 8 by a drama series reservation button (step S31). Then, a search is made for a program of a title analogous to a title of the selected program from 8-day program information (step S32). The search conditions for making a search for a program are as follows:
A channel must be identical to that of the program reserved as a drama series
A search time must be within the range of plus or minus 2 hours 10 minutes from a broadcast start time of the program reserved as a drama series; and
A title of a program must be analogous to that of the program reserved as a drama series.

It is judged whether or not a plurality of programs have been detected on different day of the week from among the corresponding program information (step S33). If they are not detected, it is judged that the day of the week of the program set for reservation every time is “reservation every week” (step S37). In the case where a plurality of different days of the week have been detected, and further, the corresponding program has been detected on Sunday in step S33, a broadcast cycle is determined as “every day” (step S38). In the case where the corresponding program has been detected on Saturday in step S34(S35), a broadcast cycle is determined as “Monday to Saturday” (step S39). In the case where the corresponding program has not been detected on Saturday in step S35, a broadcast cycle is determined as “Monday to Friday” (step S36).

In this manner, in the broadcast receiving apparatus 10, it becomes possible to very easily carry out a next time (every week) image recording reservation process for a program which is currently on broadcast receiving, by working of the drama series reserved image recording unit 42.

Image Recording Reservation Process in the Case where No Judgment Process is Carried Out

An image recording reservation process according to an embodiment of the present invention does not always require a judgment process of FIG. 4. That is, as shown in FIG. 3, steps S16 and S17 are not always mandatory. It is possible to achieve an image recording reservation process during broadcast receiving even if a broadcast cycle of a target program is not judged in accordance with the procedures of FIG. 4.

(Image Recording Reservation Process During Video Image File Reproduction/Video Image File List Displaying)

Now, with reference to flow charts of FIGS. 5 and 6, a description will be given below with respect to an image recording reservation process during video image file reproduction and an image recording reservation process during video image file list displaying.

In the broadcast receiving apparatus 10 described above, reproduction of a video image file stored in the hard disk drive unit 18 or the like is carried out by a user's operation of a remote controller R or the like. Alternatively, one video image file is specified in a state in which a video image file list (not shown) is displayed (step S41). In this state, the drama series reserved image recording unit 42 judges whether or not a drama series reservation key Y of the remote controller R has been depressed (step S42).

If a maximum number of reservations has already been reached (step S43), the drama series reserved image recording unit 42 displays a message “No more reservation. Do you cancel another reservation?” (step S51). Next, a reservation list shown in FIG. 10 is displayed by working of the drama series reserved image recording unit 42 (step S52).

Further, if the maximum number of reservations has not been reached in step S43, it is then judged whether or not program information has been acquired (step S44). If it is not acquired, message indicating “Drama series reservation cannot be made because no program information has been acquired” is displayed (step S53).

This program information (program management information) is provided as program information included in broadcast signals if a broadcast of a video image file is a terrestrial digital broadcast, a BS digital broadcast, or a CS digital broadcast.

Alternatively, if a broadcast of a video image file is by a terrestrial analog signal, this program information is provided as program information supplied from the electronic program information which has been supplied from the program information providing server S and acquired via the Internet, the modem, or the tuner unit 13.

In addition, if the program information has not been acquired in step S44, it is judged whether or not a drama series reservation of this program has already been made (step S45). If the drama series reservation of this program has already been made, a message indicating “This program has been reserved as a drama series” is displayed (step S54).

If the drama series reservation of this program has not been made yet, automatic judgment of a broadcast cycle is made from the acquired program information (step S46). This automatic judgment process will be described in detail with reference to FIG. 4 (step S56). Then, the automatically judged broadcast cycle is displayed as shown in FIG. 8 (step S57).

From the screen of FIG. 8, a user can easily set a next-round reservation or an every-week reservation with respect to a specific program of a currently viewed broadcast by pressing an icon “Yes” responsive to a message display “Do you want to make a drama series reservation?”. Further, an image recording setting screen of FIG. 9 can be invoked by operating an icon “image recording setting” of FIG. 8. Here, image recording conditions such as a tracking keyword, a tracking reference, an image quality mode, overwrite image recording, or lock setting can be set.

Then, it is judged whether or not a date and time of a tracking reference of a drama series reservation overlap on another reservation time (step S48), and a screen is displayed to ask a user whether or not to cancel another overlapped reservation (step S56). Then, a screen listing reservation information that has overlapped is displayed in order to cancel duplicate reservation by working of the drama series reserved image recording unit 42 (step S57).

On the other hand, in step S48, if the date and time of the tracking reference do not overlap on another reservation time, reservation information on a next program of the corresponding program or reservation information on the corresponding program every week is specified from the program information recorded to be associated with the already recorded video image file.

This program information (program management information) is provided as program information included in broadcast signals if a broadcast of a video image file is a terrestrial digital broadcast, a BS digital broadcast, or a CS digital broadcast. Alternatively, if a broadcast of a video image file is by a terrestrial analog signal, this program information is provided as program information supplied from the electronic program information which has been supplied from the program information providing server S and acquired via the Internet, the modem, or the tuner unit 13.

Next, a specific date and time of a program of a next time or a program of every week is specified based on channel information, time information, title information or the like included in this reservation information (step S49). Specifically, a broadcast cycle of “every week”, “every day”, “Monday to Saturday” or the like is determined by the judgment process of FIG. 4. In the range of this broadcast cycle and a plus or minus several hours from the date and time of the current broadcast, it is judged that a program of a title approximate to the current broadcast title is a next program or a program of every week. Based on the thus specified reservation information, when the date and time specified by this reservation information have come, reserved image recording is executed (step S50).

In this manner, in the broadcast receiving apparatus 10, it becomes possible, by working of the drama series reserved image recording unit 42, to very easily carry out a next time (every week) image recording reservation process for a program which is currently on broadcast receiving, during reproduction of a recorded video image file stored in the hard disk drive unit 18 or from among a recorded video image file list (not shown).

Other Image Recording Reservation Process

In the broadcast receiving apparatus 10 according to an embodiment of the present invention, further, it is possible to carry out an image recording reservation process as scheduled from a program table of FIG. 11 by working of the reserved image recording unit 42. Similarly, an image recording reservation process can be carried out from a movie list of FIG. 12.

(Application to Broadcast Receiving Apparatus)

In addition, the processing operations described with reference to these flow charts can be applied not only to the broadcast receiving apparatus 10 described above but also to a hard disk recorder or the like that is a broadcast receiving apparatus 10 having an image recording function, for example.

One skilled in the art can achieve the present embodiment in accordance with a variety of embodiments described above. Further, a variety of modified examples of these embodiments can also be easily conceived by one skilled in the art, and can be applied to a variety of embodiments even if one does not have any inventive ability. Therefore, the present invention covers a broad range without departing from a disclosed principle and novel features and is not limited to the embodiments described above.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A broadcast recording apparatus comprising:
a tuner unit which receives a broadcast signal, demodulates the received signal, and then, outputs a signal of a program;
a recording unit which records the program signal outputted by the tuner unit in a recording medium together with management information of the program;
a reproducing unit which reproduces the program signal recorded in the recording medium;
a reservation setting unit which, upon receiving an instruction signal while the reproducing unit reproduces the program signal, sets reservation information on a program of a next time in accordance with the management information; and
a reserved image recording unit which, when a time indicated by the reservation information has come, controls the recording unit to record the program signal in the recording medium.

2. The broadcast recording apparatus according to claim 1, wherein the reservation setting unit sets reservation information for performing image recording reservation of a series-related program scheduled to be broadcast every week or everyday.

3. The broadcast recording apparatus according to claim 1, wherein the reservation setting unit has a function of automatically judging a broadcast cycle at which the program is to be repeatedly broadcast, and sets reservation information at the judged broadcast cycle.

4. The broadcast recording apparatus according to claim 1, wherein an image recording condition of the program of the next time to be reserved by the reservation setting unit is identical to an image recording condition of the program signal recorded in the recording unit.

5. The broadcast recording apparatus according to claim 1, wherein the reservation setting unit further sets reservation information on the program of the next time by operating the broadcast signal received by the tuner unit from a screen of an electronic program table.

6. The broadcast recording apparatus according to claim 1, wherein the reservation setting unit sets reservation information on the program of the next time being received in response to an operating signal in a state in which the tuner unit receives and demodulates the broadcast signal, and then, displays a video image on an imaging unit in response to a program signal.

7. The broadcast recording apparatus according to claim 1, wherein the management information on the program is electronic program information or one of title information, channel information, broadcast time information, and performer information included in the broadcast signal.

8. A broadcast recording method comprising:
receiving a broadcast signal, demodulating the received signal, and then, outputting a signal of a program;
recording the program signal in a recording medium together with management information of the program;
reproducing the program signal recorded in the recording medium;
upon receiving an instruction signal while reproducing the program signal, setting reservation information on a program of a next time in accordance with the management information; and
when a time indicated by the reservation information has come, recording the program signal in the recording medium.

9. The broadcast recording method according to claim 8, wherein reservation information is set for performing image recording reservation of a series-related program scheduled to be broadcast every week or everyday.

10. The broadcast recording method according to claim 8, wherein there is provided a function of automatically judging a broadcast cycle at which the program is to be repeatedly broadcast, and reservation information is set at the judged broadcast cycle.

11. The broadcast recording method according to claim 8, wherein an image recording condition of the program of the next time to be reserved is identical to an image recording condition of the program signal.

12. The broadcast recording method according to claim 8, wherein reservation information on the program of the next time is set by operating the received broadcast signal from a screen of an electronic program table.

13. The broadcast recording method according to claim 8, wherein reservation information on the program of the next time being received in response to an operating signal is set in a state in which the broadcast signal is received and demodulated to display a video image on an imaging unit in response to the program signal.

14. The broadcast recording method according to claim 8, wherein the management information on the program is electronic program information or one of title information, channel information, broadcast time information, and performer information included in the broadcast signal.
